(19) United States
(12) Patent Application Publication
(10) Pub. No.: US 2026/0188587 A1
(43) Pub. Date: Jul. 2, 2026

(54) MULTILAYER ELECTRONIC COMPONENT

(71) Applicant: SAMSUNG ELECTRO-MECHANICS CO., LTD., Suwon-si (KR)

(72) Inventors: Sung Hyun KANG, Suwon-si (KR); Seung Ho RHEE, Suwon-si (KR); Chae Dong LEE, Suwon-si (KR)

(73) Assignee: SAMSUNG ELECTRO-MECHANICS CO., LTD., Suwon-si (KR)

(21) Appl. No.: 19/365,556

(22) Filed: Oct. 22, 2025

(30) Foreign Application Priority Data
Dec. 27, 2024 (KR) 10-2024-0198410
Mar. 21, 2025 (KR) 10-2025-0036666

(51) Int. Cl. H01G 4/232; H01G 4/008; H01G 4/012; H01G 4/12; H01G 4/30

(52) U.S. Cl. CPC H01G 4/2325; H01G 4/008; H01G 4/012; H01G 4/12; H01G 4/30

(57) ABSTRACT

A multilayer electronic component may include: a body including a dielectric layer and internal electrodes alternately disposed with the dielectric layer in a thickness direction; first and second side margin portions respectively disposed on the fifth and sixth surfaces of the body opposing each other in a width direction; a first glass layer and a second glass layer disposed on the first and second side margins and extending respectively to portion of a third surface of the body and a fourth surface of the body opposing the third surface in a length direction; and first and second external electrodes respectively disposed on the third and fourth surfaces. The internal electrode includes first internal and second electrodes having both ends thereof in the width direction covered respectively by the first and second glass layers on the third surface and fourth surfaces.

### CROSS-REFERENCE TO RELATED APPLICATION(S)

This application claims the benefit of priority to Korean Patent Application No. 10-2024-0198410 filed on Dec. 27, 2024 and Korean Patent Application No. 10-2025-0036666 filed on Mar. 21, 2025 in the Korean Intellectual Property Office, the disclosure of which is incorporated herein by reference in its entirety.

### TECHNICAL FIELD

The present disclosure relates to a multilayer electronic component.

### BACKGROUND

A multilayer ceramic capacitor (MLCC), a multilayer electronic component, is a chip-type condenser, mounted on the printed circuit boards of various types of electronic product, such as image display devices, including a liquid crystal display LCD and a plasma display panel PDP, computers, smartphones and mobile phones, and serves to charge or discharge electricity therein or therefrom.

These multilayer ceramic capacitors may be used as a component of various electronic devices, since a multilayer ceramic capacitor may have a small size and high capacitance and may be easily mounted.

Recently, with the implementation of miniaturization and high performance in electronic devices, multilayer ceramic capacitors have also been trending toward being miniaturized and having higher capacitance, and the importance of ensuring high reliability of multilayer ceramic capacitors is increasing. Additionally, high reliability characteristics are required for use in automotive electronic components.

In order to implement miniaturization and high capacitance in a multilayer ceramic capacitors, maximization of an effective electrode area (an increase in an effective volume fraction required to realize capacitance) is required.

In order to achieve a small-sized and high capacitance multilayer ceramic capacitor as described above, in manufacturing the multilayer ceramic capacitor, by exposing an internal electrode in a width direction of a body, an area of the internal electrodes in the width direction is maximized through a marginless design, and prior to sintering, a ceramic green sheet for a side margin portion is separately attached to an exposed surface of the electrode in the width direction of the body, and then sintering is performed.

While the side margin portion is formed by separately attaching the ceramic green sheet for the side margin portion, the capacitance per unit volume of the capacitor may be improved, but stress may occur at a bonding interface between the side margin portion and the body during sintering, which may cause problems such as delamination and cracks or the like. Additionally, there may be concern that moisture may penetrate through gaps formed by delamination, cracks, and the like, thereby reducing reliability.

Therefore, development of multilayer electronic components capable of improving reliability by suppressing the occurrence of delamination, cracks, or the like, may be needed.

### SUMMARY

An aspect of the present disclosure is to provide a multilayer electronic component having excellent reliability.

An aspect of the present disclosure is to provide the multilayer electronic component having excellent capacitance per unit volume.

An aspect of the present disclosure is to provide the multilayer electronic component in which delamination, cracks, or the like in the side margin portion are suppressed.

An aspect of the present disclosure is to provide the multilayer electronic component with excellent moisture resistance reliability.

However, problems to be solved by the present disclosure are not limited to the above, and will be more easily understood in the process of describing specific embodiments of the present disclosure.

A multilayer electronic component according to an embodiment of the present disclosure may comprise: a body including a dielectric layer and internal electrodes alternately disposed with the dielectric layer in a thickness direction, first and second surfaces opposing each other in the thickness direction, third and fourth surfaces opposing each other in a length direction, and fifth and sixth surfaces opposing each other in a width direction; first and second side margin portions respectively disposed on the fifth and sixth surfaces; a first glass layer disposed on the first and second side margin portions and disposed to extend onto a portion of the third surface; a second glass layer disposed on the first and second side margin portions and disposed to extend onto a portion of the fourth surface; and first and second external electrodes respectively disposed on the third and fourth surfaces, wherein the internal electrodes may include a first internal electrode having both end portions in a width direction covered by the first glass layer on the third surface, and a second internal electrode having both end portions in the width direction covered by the second glass layer on the fourth surface.

According to an aspect of the present disclosure, the reliability of a multilayer electronic component may be improved by having the glass layer disposed on the side margin and extending to the third or fourth side of the body.

According to an aspect of the present disclosure, capacitance per unit volume of the multilayer electronic component may be improved.

According to an aspect of the present disclosure, the occurrence of delamination, cracks, or the like in the side margin portion may be suppressed.

According to an aspect of the present disclosure, moisture resistance reliability of the multilayer electronic component may be improved.

However, the purpose of the present disclosure is not limited to the above-described content, and may be more easily understood in the process of explaining specific embodiments of the present disclosure.

### BRIEF DESCRIPTION OF DRAWINGS

FIG. 1 schematically illustrates a perspective view of a multilayer electronic component according to an embodiment of the present disclosure.

FIG. 2 is a perspective view illustrating FIG. 1 excluding an external electrode.

FIG. 3 is a perspective view illustrating FIG. 2 excluding a glass layer.

FIG. 4 is a perspective view illustrating FIG. 3 excluding a side margin portion.

FIG. 5 schematically illustrates a cross-sectional view taken along line I-I′ of FIG. 1.

FIG. 6 schematically illustrates a cross-sectional view taken along line II-II′ of FIG. 1.

FIG. 7 schematically illustrates a cross-sectional view taken along line III-III′ of FIG. 1.

FIG. 8 is an enlarged view of a P1 region of FIG. 7.

FIG. 9A is an image scanned by SEM of a region corresponding to the P1 region of an embodiment of the present disclosure and FIG. 9B is an image captured by an optical microscope of a region corresponding to the P1 region of an embodiment of the present disclosure.

FIG. 10 schematically illustrates a perspective view of a multilayer electronic component according to another embodiment of the present disclosure.

FIG. 11 schematically illustrates a cross-sectional view taken along line IV-IV′ of FIG. 10.

FIG. 12 is a drawing for explaining a lamination process.

FIG. 13 is a drawing for explaining a cutting process.

FIG. 14 is a drawing illustrating a unit laminate after the cutting process.

FIG. 15 is a drawing for explaining the side margin attachment process.

FIG. 16 is a drawing illustrating a unit laminate having a first side margin portion attached.

FIG. 17 is a drawing for explaining a glass layer formation process.

### DETAILED DESCRIPTION

Hereinafter, embodiments of the present disclosure will be described with reference to specific embodiments and the accompanying drawings. However, embodiments of the present disclosure may be modified into various other forms, and the scope of the present disclosure is not limited to the embodiments described below. Further, embodiments of the present disclosure may be provided for a more complete description of the present disclosure to the ordinary artisan. Therefore, shapes and sizes of the elements in the drawings may be exaggerated for clarity of description, and the elements denoted by the same reference numerals in the drawings may be the same elements.

In the drawings, portions not related to the description will be omitted for clarification of the present disclosure, and a thickness may be enlarged to clearly illustrate layers and regions. The same reference numerals will be used to designate the same components with the same reference numerals. Further, throughout the specification, when an element is referred to as “comprising” or “including” an element, it means that the element may further include other elements as well, without departing from the other elements, unless specifically stated otherwise.

In the drawing, an X-direction may be defined as a first direction, a stacking direction or a thickness T direction, a Y-direction may be defined as a second direction or a length L direction, and a Z-direction may be defined as a third direction or a width W direction.

### Multilayer Electronic Component

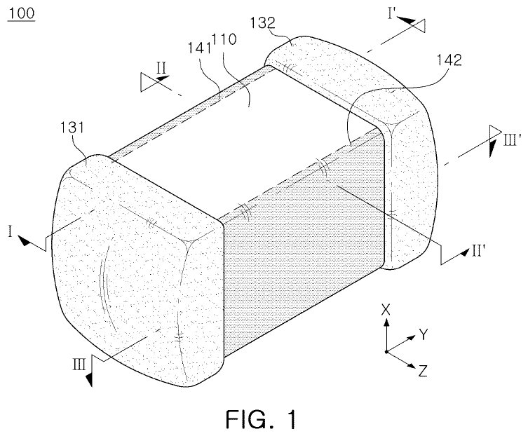

FIG. 1 schematically illustrates a perspective view of a multilayer electronic component according to an embodiment of the present disclosure.

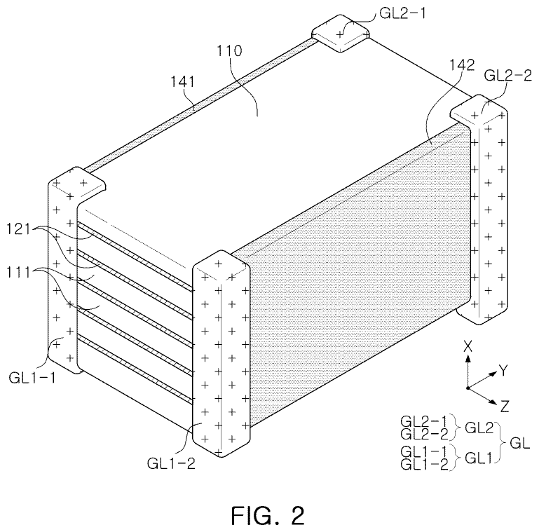

FIG. 2 is a perspective view illustrating FIG. 1 excluding an external electrode.

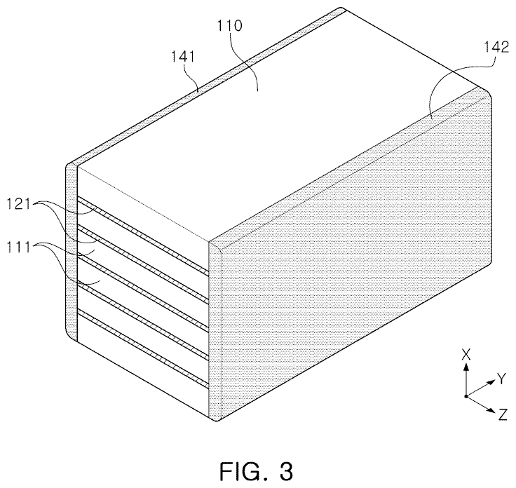

FIG. 3 is a perspective view illustrating FIG. 2 excluding a glass layer.

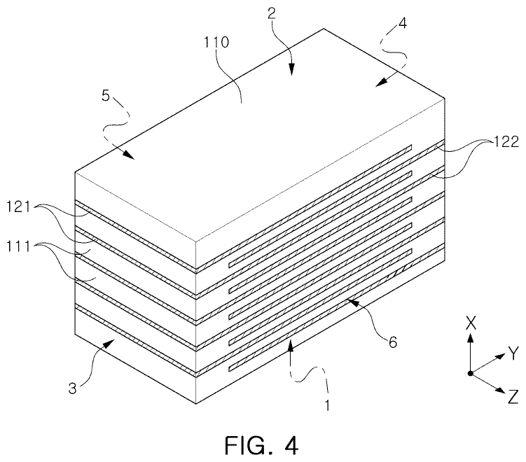

FIG. 4 is a perspective view illustrating FIG. 3 excluding a side margin portion.

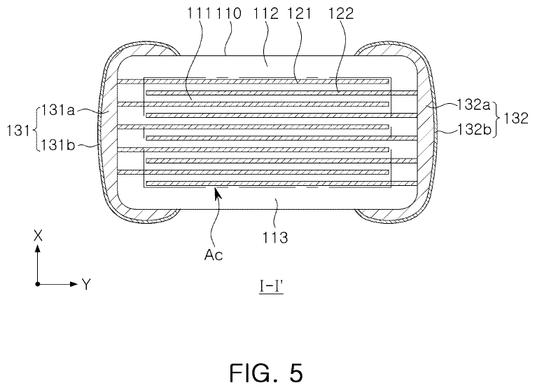

FIG. 5 schematically illustrates a cross-sectional view taken along line I-I′ of FIG. 1.

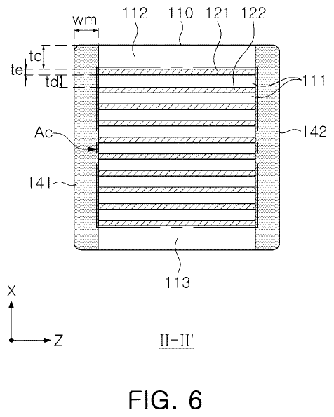

FIG. 6 schematically illustrates a cross-sectional view taken along line II-II′ of FIG. 1.

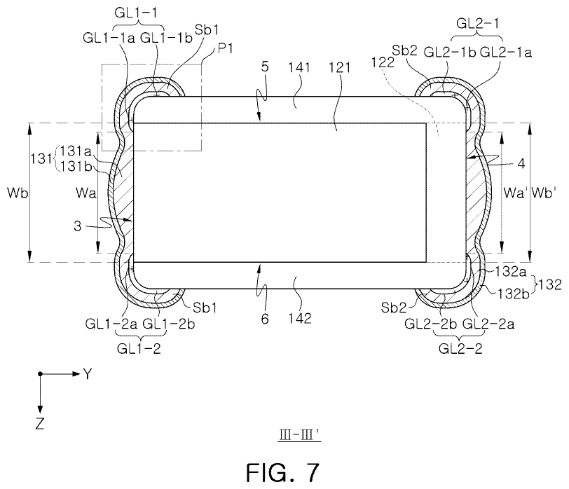

FIG. 7 schematically illustrates a cross-sectional view taken along line III-III′ of FIG. 1.

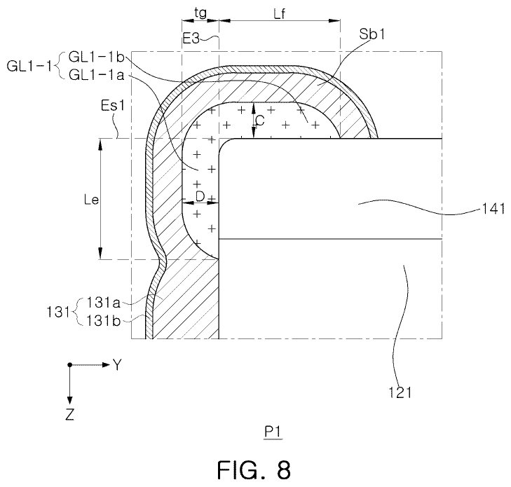

FIG. 8 is an enlarged view of a P1 region of FIG. 7.

Hereinafter, a multilayer electronic component 100 according to an embodiment of the present disclosure will be described in detail with reference to FIGS. 1 to 8.

According to an embodiment of the present disclosure, a multilayer electronic component 100 comprises: a body 110 including a dielectric layer 111 and internal electrodes 121 and 122 alternately disposed with the dielectric layer in a thickness direction, and including first and second surfaces 1 and 2 opposing each other in the thickness direction, third and fourth surfaces 3 and 4 opposing each other in a length direction, and fifth and sixth surfaces 5 and 6 opposing each other in a width direction; first and second side margin portions 141 and 142 respectively disposed on the fifth and sixth surfaces; a first glass layer GL1 disposed on the first and second side margin portions and extending to a portion of the third surface; a second glass layer GL2 disposed on the first and second side margin portions and extending to a portion of the fourth surface; first and second external electrodes 131 and 132 respectively disposed on the third and fourth surfaces, wherein the internal electrodes may include a first internal electrode 121 having both end portions in the width direction covered by the first glass layer on the third surface, and a second internal electrode 122 having both end portions in a width direction covered by the second glass layer on the fourth surface.

While the side margin portion is formed by separately attaching the ceramic green sheet for the side margin portion, the capacitance per unit volume of the capacitor may be improved, but stress may be occurred at a bonding interface between the side margin portion and the body during sintering, which may cause problems such as delamination and cracks or the like. Additionally, there may be concern that moisture penetrated through gaps formed by delamination, cracks, and the like, thereby reducing reliability.

According to an embodiment of the present disclosure, the glass layer may be disposed on the side margin portion and extends to the third or fourth surface of the body, thereby suppressing occurrence of delamination, cracks, or the like, and preventing moisture penetration by blocking a moisture penetration path, therefore, improving the reliability of the multilayer electronic component.

Hereinafter, each component included in the multilayer electronic component 100 according to an embodiment of the present disclosure will be described in detail.

The body 110 is not limited to a particular shape, and may have a hexahedral shape or a shape similar to the hexahedral shape, as illustrated in the drawings. The body 110 may not have a hexahedral shape having perfectly straight lines because ceramic powder particles included in the body 110 may contract in a process in which the body is sintered, however, the body 110 may have a substantially hexahedral shape.

Referring to FIG. 4, the body 110 may have first and second surfaces 1 and 2 opposing each other in a thickness direction (X-direction), third and fourth surfaces 3 and 4 connected to the first and second surfaces 1 and 2 and opposing each other in a length direction (Y-direction), and fifth and sixth surfaces 5 and 6 connected to the first and second surfaces 1 and 2, connected to the third and fourth surfaces 3 and 4, and opposing each other in a width direction (Z-direction).

A plurality of dielectric layers 111 forming the body 110 are in a sintered state, and adjacent dielectric layers 111 may be integrated with each other, such that boundaries therebetween may not be readily apparent without a scanning electron microscope SEM.

According to an embodiment of the present disclosure, a raw material forming the dielectric layer 111 is not particularly limited, as long as sufficient electrostatic capacitance may be obtained. For example, barium titanate-based materials, lead composite perovskite-based materials, strontium titanate-based materials, or the like may be used. The barium titanate-based materials may include a BaTiO₃-based ceramic powder, and examples of the ceramic powder may include BaTiO₃, BaTiO₃ in which calcium Ca, zirconium Zr, or the like are partially substituted, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), or Ba(Ti_{1-y}Zr_{y})O₃ (0<y<1).

In addition, the raw material forming the dielectric layer 111 may be a powder such as barium titanate (BaTiO₃), to which various ceramic additives, organic solvents, binders, dispersants, and the like may be added according to the purpose of the present disclosure.

An average thickness td of the dielectric layer 111 is not particularly limited, and may be arbitrarily set according to desired characteristics or purpose. For a specific example, the average thickness td of the dielectric layer 111 may be 300 nm or greater and 10 μm or less. Additionally, the average thickness td of at least one or more of the plurality of dielectric layers 111 may be 300 nm or greater and 10 μm or less.

In this case, the average thickness td of the dielectric layer 111 may refer to an average thickness of the dielectric layer 111 disposed between the first and second internal electrodes 121 and 122.

The average thickness of the dielectric layer 111 may be measured by scanning cross-sections (L-T cross-sections) of the body 110 in the length and thickness direction with a scanning electron microscope SEM of 10,000× magnification. More specifically, the thickness of one dielectric layer may be measured at 30 points equally spaced apart from each other in the length direction in the scanned image, and the average value may be measured. The 30 points which are equally spaced apart, may be designated in the capacitance formation portion Ac. Additionally, when measuring the average value measurement is expanded to 10 dielectric layers to calculate the average value, the average thickness of the dielectric layer may be further generalized.

The internal electrodes 121 and 122 may be a pair of the first internal electrode 121 and the second internal electrode 122 having different polarities each other. A plurality of internal electrodes 121 and 122 disposed inside the body 110 may have one ends exposed to the third surface 3 or the fourth surface 4 of the body.

The first and second internal electrodes 121 and 122 may be alternately disposed in the first direction with the dielectric layer 111 interposed therebetween.

One end of the first internal electrode 121 may be exposed to the third surface 3, and one end of the second internal electrode 122 may be exposed to the fourth surface 4. The other end of the first internal electrode 121 may be spaced apart from the fourth surface 4, and the other end of the second internal electrode 122 may be spaced apart from the third surface 3. In an embodiment, the first internal electrode 121 may be exposed to the third, fifth and sixth surfaces, and the second internal electrode 122 may be exposed to the fourth, fifth and sixth surfaces. The side margin portions 141 and 142 may be disposed to cover the internal electrodes 121 and 122 exposed to the fourth and sixth surfaces. Accordingly, the capacitance per unit volume of the multilayer electronic component may be improved. The first external electrode 131 may be disposed on the third surface 3 of the body to be connected to the first internal electrode 121, and a second external electrode 132 may be disposed on the fourth surface 4 of the body to be connected to the second internal electrode 122.

The internal electrodes 121 and 122 may be stacked in more than 400 or more layers to implement a high capacitance multilayer electronic component, but are not necessarily limited thereto.

Materials forming the internal electrodes 121 and 122 is not particularly limited, and the materials having excellent electrical conductivity may be used. For example, the internal electrodes 121 and 122 may include one or more of nickel (Ni), copper (Cu), palladium (Pd), silver (Ag), gold (Au), platinum (Pt), tin (Sn), tungsten (W), titanium (Ti), and alloys thereof.

In addition, the internal electrodes 121 and 122 may be formed by printing a conductive paste for internal electrodes containing one or more of nickel (Ni), copper (Cu), palladium (Pd), silver (Ag), gold (Au), platinum (Pt), tin (Sn), tungsten (W), titanium (Ti), and alloys thereof on a ceramic green sheet. The printing method for the conductive paste for the internal electrodes may use a screen printing method or a gravure printing method, but the present disclosure is not limited thereto.

An average thickness te of the internal electrodes 121 and 122 is not particularly limited. For example, the average thickness te of the internal electrodes 121 and 122 may be 0.2 μm or greater and 3 μm or less.

The average thickness te of the internal electrodes 121 and 122 may refer to an average thickness of the internal electrodes 121 and 122.

The average thickness of the internal electrodes 121 and 122 may be measured by scanning cross-sections (L-T cross-sections) of the body 110 in the length and thickness direction with a scanning electron microscope SEM of 10,000× magnification. More specifically, the thickness of one internal electrode may be measured at 30 points equally spaced apart from each other in the length direction, and then taking the average value. The 30 points which are equally spaced apart, may be designated in the capacitance formation portion Ac. Additionally, when measuring the average value measurements is expanded to 10 internal electrodes to calculate the average value, the average thickness of the internal electrodes may be further generalized.

The body 110 may include the capacitance formation portion Ac, in which dielectric layers and internal electrodes may be alternately disposed in the thickness direction, and cover portions 112 and 113 disposed an upper portion and a lower portion of the capacitance formation portion in the thickness direction.

The cover portions 112 and 113 may include an upper cover portion 112 disposed on the upper portion of the capacitance formation portion Ac in the thickness direction and a lower cover portion 113 disposed on the lower portion of the capacitance formation portion Ac in the thickness direction.

The capacitance formation portion Ac may be a portion contributing to the capacitance formation of the capacitor, and may be formed by repeatedly stacking a plurality of first and second internal electrodes 121 and 122 with the dielectric layer 111 therebetween.

The cover portions 112 and 113 may be formed by stacking a single dielectric layer 111 or two or more dielectric layers 111 on the upper and lower surfaces of the capacitance formation portion Ac in the thickness direction, respectively, and may contribute to basically prevent damage to the internal electrode due to physical or chemical stress.

The cover portions 112 and 113 may not include the internal electrode, and the cover portions 112 and 113 may include BaTiO₃, BaTiO₃ partially containing Ca (calcium), Zr (zirconium), or the like, (Ba₁₋ₓCaₓ)TiO₃ (0<x<1), Ba(Ti_{1-y}Ca_{y})O₃ (0<y<1), (Ba₁₋ₓCaₓ) (Ti_{1-y}Zr_{y})O₃ (0<x<1, 0<y<1), or Ba(Ti_{1-y}Zr_{y})O₃ (0<y<1), or the like.

An average thickness of the cover portions 112 and 113 is not particularly limited. For example, a thickness tc of the cover portions 112 and 113 may be 10 to 300 μm. However, in order to more easily achieve miniaturization and high capacitance of the multilayer electronic component, the thickness tc of the cover portions 112 and 113 may be 15 μm or less. That is, the average thickness tc of an upper cover portion 112 may be 15 μm or less, and the average thickness tc of a lower cover portion 113 may also be 15 μm or less.

The average thickness tc of the cover portions 112 and 113 may refer to a size in the thickness direction, and may be an average value of a size of the cover portions 112 and 113 in the thickness direction measured at 5 equally spaced apart points on the upper or lower portions of the capacitance formation portion Ac.

The side margin portions 141 and 142 may be disposed on the fifth and sixth surfaces 5 and 6, respectively. The side margin portions 141 and 142 may include a first side margin portion 141 disposed on the fifth surface 5 of the body 110 and a second side margin portion 142 disposed on the sixth surface 6 of the body 110.

The side margin portions 141 and 142 may include a perovskite type compound represented by ABO₃ as a main component, and the perovskite compound represented by ABO3 may include, for example, one or more of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1) and Ba(Ti_{1-y}Zr_{y})O₃ (0<y<1). That is, the side margin portions 141 and 142 may include Ba and Ti. The side margin portions 141 and 142 may further include one or more of Ca and Zr to prevent dielectric characteristics from being degraded under high temperature/high voltage conditions, but the present disclosure is not limited thereto.

In the present disclosure, the “main component” of the side margin portions 141 and 142 may refer to a component occupying a relatively large weight ratio or atomic number ratio compared to other components, and may refer to a component exceeding 50 wt % based on the total weight of the composition or the entire side margin portion, exceeding 50 at % based on the number of atoms, or exceeding 50 mol % based on the number of moles.

The side margin portions 141 and 142 may contribute to prevent damage to the internal electrodes due to physical or chemical stress. Additionally, it may contribute to suppress a step difference caused by the internal electrodes 121 and 122, and improve the capacitance per unit volume of the multilayer electronic component 100.

The side margin portions 141 and 142 may be formed by stacking a single dielectric layer or two or more dielectric layers in the width direction on the fifth and sixth surfaces 5 and 6 of the body, where both the first and second internal electrodes 121 and 122 may be exposed.

A width of side margin portions 141 and 142 is not particularly limited. For example, the width of the side margin portions 141 and 142 may be 5 μm to 300 μm. However, in order to more easily achieve miniaturization and high capacitance of the multilayer electronic component and to improve the capacitance per unit volume of the multilayer electronic component, an average width wm of the side margin portions 141 and 142 may be 15 μm or less.

The average width wm of the side margin portions 141 and 142 may refer to an average size of the side margin portions 141 and 142 in the width direction, and may be an average value of the size of the side margin portions 141 and 142 in the width direction measured at 5 equally spaced apart points in the thickness direction.

The glass layer GL may be disposed on the side margin portions 141 and 142, and extend to the third or fourth surface.

The glass layer GL may include a first glass layer GL1 disposed on the first and second side margin portions 141 and 142 and extending to a portion of the third surface, and a second glass layer GL2 disposed on the first and second side margin portions 141 and 142 and extending to a portion of the fourth surface. The internal electrodes 121 and 122 may include the first internal electrode 121 having both end portions in the width direction (Z-direction) on the third surface 3 covered by the first glass layer GL1, and the second internal electrode 122 having both end portions in the width direction (Z-direction) on the fourth surface 4 covered by the second glass layer. Accordingly, the bonding force between the side margin portions 141 and 142 and the body may be improved, and the moisture resistance reliability may be improved by blocking or lengthening a moisture penetration path.

Among the first internal electrode 121 exposed to the third surface, a region not covered by the first glass layer GL1 may be directly connected to the first external electrode 131, and among the second internal electrode 122 exposed to the fourth surface, a region not covered by the second glass layer GL2 may be directly connected to the second external electrode 132.

The first glass layer GL1 may include a 1-1 glass layer GL1-1 disposed on one surface of the first side margin portion 141 in the length direction and a 1-2 glass layer GL1-2 disposed on one surface of the second side margin portion 142 in the length direction, and the second glass layer GL2 may include a 2-1 glass layer GL2-1 disposed on the other surface of the first side margin portion 141 in the length direction and a 2-2 glass layer GL2-2 disposed on the other surface of the second side margin portion 142 in the length direction.

The 1-1 glass layer GL1-1 may be disposed on one surface of the first side margin portion 141 in the length direction and may cover one end portion of the first internal electrode 121 exposed to the third surface by extending to the third surface in the width direction, and the 1-2 glass layer GL1-2 may be disposed on one surface of the second side margin portion 142 in the length direction and may cover the other end portion of the first internal electrode 121 exposed to the third surface by extending to the third surface in the width direction.

The 2-1 glass layer GL2-1 may be disposed on the other surface of the first side margin portion 141 in the length direction and may cover one end portion of the second internal electrode 122 exposed to the fourth surface by extending to the fourth surface in the width direction, and the 2-2 glass layer GL2-2 may be disposed on the other surface of the second side margin portion 142 in the length direction and may cover one end of the second internal electrode 122 exposed to the fourth surface by extending to the fourth surface in the width direction.

In an embodiment, when a width of the first internal electrode 121 in the third direction is Wb and a width of the first internal electrode 121 in the third direction not covered by the first glass layer GL1 is Wa, an average value of Wa/Wb may be 0.90 or greater and 0.98 or less. Accordingly, the reliability improvement effect according to the present disclosure may be further improved, degraded electrical connectivity between the external electrodes 131 and 132 and the internal electrodes 121 and 122 may be suppressed, and an equivalent series resistance ESR of the multilayer electronic component 100 may be reduced.

Therefore, it is preferable that the average value of Wa/Wb be 0.90 or greater and 0.98 or less, and more preferably 0.94 or greater and 0.98 or less.

Because the first internal electrode 121 and the first glass layer GL1, and the second internal electrode 122 and the second glass layer GL2, may be symmetrical in the length direction (Y-direction), when a width of the second internal electrode in third direction is Wb′ and a width of the second internal electrode not covered by the second glass layer in the third direction is Wa′, the average value of Wa′/Wb′ may be 0.90 or greater and 0.98 or less.

The Wa, Wb, Wa′ and Wb′ may be measured, for example, from an image of a cross-section in length and width direction (L-W cross-section), which is polished to a center portion of the of the multilayer electronic component 100 in the thickness direction and observed using an optical microscope OM or a scanning electron microscope SEM.

Hereinafter, the description will focus on the first internal electrode 121 and the first glass layer GL1, but it may also be applied to correspond to the second internal electrode 122 and the second glass layer GL2. Additionally, since the 1-1 glass layer GL1-1 and the 1-2 glass layer GL1-2 may be symmetrical in the width direction, and the 2-1 glass layer GL2-1 and the 2-2 glass layer GL2-2 may also be symmetrical in the width direction, the following description will focus on the 1-1 glass layer GL1-1, but it may also be applied to correspond to the 1-2 glass layer GL1-2, the 2-1 glass layer GL2-1, and the 2-2 glass layer GL2-2, by considering the respective symmetry relationships.

In an embodiment, an average thickness (tg) of the first and second glass layers may be 5 μm or greater and 15 μm or less, respectively.

The average thickness of the first glass layer may be measured on one surface of the third surface and the first side margin portion, and the average thickness of the second glass layer may be measured on the other surface of the fourth surface and the second side margin portion.

Referring to FIG. 8, a distance from the end of the 1-1 glass layer GL1-1 disposed on the third surface to an extension line Es1 of an external surface of the first side margin portion in the width direction is divided into ten equal portions, and then an average value of a size of the 1-1 glass layer GL1-1 in the second direction measured at the central 5 points, may be defined as an average thickness of the 1-1 glass layer GL1-1, and an average thickness of the 1-2 glass layer GL1-2 may also be measured by using in a similar manner, and an average value of the average thickness of the 1-1 glass layer GL1-1 and 1-2 glass layer GL1-2 may be the average thickness of the first glass layer GL1. Additionally, the average thickness of the second glass layer GL2 may also be measured and obtained in a similar manner.

In an embodiment, the 1-1 and 2-1 glass layers GL1-1 and GL2-1 may include side-surface extension portions GL1-1b and GL2-1b disposed extending to an external surface of the first side margin portion 141 in the width direction, respectively, and the 1-2 and 2-2 glass layers GL1-2 and GL2-2 may include side-surface extension portions GL1-2b and GL2-2b disposed extending to an external surface of the second side margin portion 142 in the width direction, respectively. In this case, a surface not in contact with the fifth surface among both surfaces of the first side margin portion 141 in the width direction may be defined as an external surface of the first side margin portion 141 in the width direction, and a surface in contact with the fifth surface among both surfaces of the first side margin portion 141 in the width direction may be defined as an internal surface of the first side margin portion 141 in the width direction. Similarly, a surface not in contact with the sixth surface among both surfaces of the second side margin portion 142 in the width direction may be defined as an external surface of the second side margin portion 142 in the width direction, and a surface in contact with the sixth surface among both surfaces of the second side margin portion 142 in the width direction may be defined as an internal surface of the second side margin portion 142 in the width direction.

Referring to FIG. 7, the 1-1 glass layer GL1-1 may include a region GL1-1a disposed on one surface of the first side margin portion 141 in the length direction and the 1-1 side-surface extension portion GL1-1b disposed extending to the external surface of the first side margin portion 141 in the width direction. The 2-1 glass layer GL2-1 may include a region GL2-1a disposed on the other surface of the first side margin portion 141 in the length direction and the 2-1 side-surface extension portion GL2-1b disposed extending to the external surface of the first side margin portion 141 in the width direction. The 1-2 glass layer GL1-2 may include a region GL1-2a disposed on one surface of the second side margin portion 142 in the length direction and the 1-2 side extension portion GL1-2b disposed extending to the external surface of the second side margin portion 142 in the width direction. The 2-2 glass layer GL2-2 may include a region GL2-2a disposed on the other surface of the second side margin portion 142 in the length direction and a 2-2 side-surface extension portion GL2-2b disposed extending to the external surface of the second side margin portion 142 in the width direction. As the glass layer GL may include the side-surface extension portions GL1-1b, GL1-2b, GL2-1b, and GL2-2b, the bonding force between the side margin portions 141 and 142 and the body 110 may be further improved.

The first glass layer GL1 may include a first side-surface extension portions GL1-1b and GL1-2b, and the second glass layer GL2 may include a second side-surface extension portions GL2-1b and GL2-2b.

In an embodiment, when a length from an extension line Es1 of the external surface of the first side margin portion 141 in the width direction to the end of the 1-1 glass layer GL1-1 disposed on the third surface in the width direction is Le, and a length from an extension line E3 of the third surface to the end of the side-surface extension portion GL1-1b of the 1-1 glass layer GL1-1 in the length direction is Lf, Le/Lf may be 0.8 or greater and 1.2 or less.

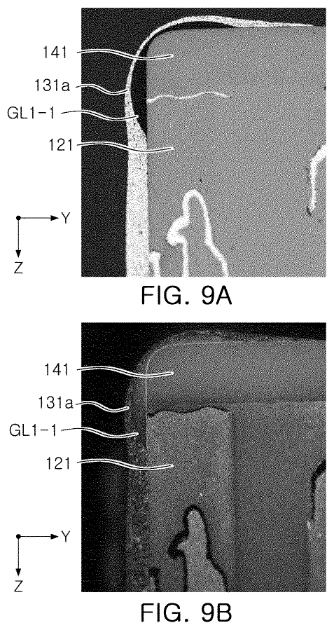

A ratio D/C of a maximum thickness D of the region GL1-1a disposed on one surface of the first side margin portion 141 in the length direction compared to a maximum thickness C of the 1-1 side-surface extension portion GL1-1b, disposed extending to the first side margin portion 141 in the width direction is not particularly limited. For example, D/C may be 0.5 or greater and 1.5 or less, but is not limited thereto and may be D>C as illustrated in FIGS. 9A and 9B.

The maximum thickness C of the 1-1 side-surface extension portion GL1-1b may refer to a maximum size from the external surface of the first side margin portion 141 in the width direction, and the maximum thickness D of the region GL1-1a disposed on one surface of the first side margin portion 141 in the length direction may refer to the maximum size in the length direction from the third surface.

In an embodiment, the first and second glass layers GL1 and GL2 may include the side-surface extension portions GL1-1b, GL1-2b, GL2-1b, and GL2-2b extending to the external surface of the first side margin portion in the width direction and the external surface of the second side margin portion in the width direction, respectively, and the first and second external electrodes 131 and 132 may include side-surface band portions Sb1 and Sb2 extending to the external surface of the first side margin portion in the width direction and the external surface of the second side margin portion, respectively.

The first external electrode 131 may include a first side-surface band portion Sb1 extended from the external surface of the first side margin portion 141 in the width direction and the external surface of the second side margin portion 142 in the width direction, and the second external electrode 132 may include a second side-surface band portion Sb2 extended from the external surface of the first side margin portion 141 in the width direction and the external surface of the second side margin portion 142 in the width direction.

In an embodiment, the side-surface band portions Sb1 and Sb2 may be disposed to cover all of the side-surface extension portions GL1-1b, GL1-2b, GL2-1b, and GL2-2b.

The first side-surface band portion Sb1 may be disposed to cover all of the first side-surface extension portions GL1-1b and GL1-2b, and the second side-surface band portion Sb2 may be disposed to cover all of the second side-surface extension portions GL2-1b and GL2-2b.

In an embodiment, the first and second glass layers GL1 and GL2 may include an upper and lower surface extension portions extending to both surfaces of the first side margin portion 141 in the thickness direction and both surfaces of the second side margin portion 142 in the thickness direction, respectively.

Referring to FIG. 2, the first glass layer GL1 may include the upper and lower surface extension portion extending to both surfaces of the first side margin portion 141 in the thickness direction and both surfaces of the second side margin portion 142 in the thickness direction, and the upper and lower surface extension portion may cover portions of the first and second surfaces 1 and 2 of the body 110. In addition, the second glass layer GL2 may also include the upper and lower surface extension portion extending to both surfaces of the first side margin portion 141 in the thickness direction and both surfaces of the second side margin portion 142 in the thickness direction, and the upper and lower surface extension portion may cover portions of the first and second surfaces 1 and 2 of the body 110.

In this case, the first and second external electrodes 131 and 132 may each include the upper and lower surface extension portion extending to both surfaces of the first side margin portion in the thickness direction and to both surfaces of the second side margin portion in the thickness direction, and the upper and lower band portion may be disposed to cover all of the upper and lower surface extension portions.

In an embodiment, 4 vertices disposed at the edge of external surface of the first side margin portion 141 in the width direction and 4 vertices disposed at the edge of external surface of the second side margin portion 142 in the width direction may be covered by the first glass layer GL1 or the second glass layer GL2. Accordingly, a hermetic sealing effect by the glass layers GL1 and GL2 may be further improved, thereby further improving reliability, according to the present disclosure.

External electrodes 131 and 132 may be disposed on the third and fourth surfaces 3 and 4, respectively. The multilayer electronic component 100 may include the first external electrode 131 disposed on the third surface 3 and the second external electrode 132 disposed on the fourth surface 4. The first and second external electrodes 131 and 132 may extend onto a portion of the first and second surfaces 1 and 2, respectively.

A type or shape of the external electrodes 131 and 132 is not particularly limited and may have a multilayer structure. For example, the external electrodes 131 and 132 may include base electrode layers 131a and 132a in contact with the internal electrodes 121 and 122 and plating layers 131b and 132b disposed on the base electrode layers 131a and 132a.

The base electrode layers 131a and 132a may be sintered electrode layers including metal and glass. The metal included in the base electrode layers 131a and 132a may include, for example, Cu, Ni, Pd, Pt, Au, Ag, Pb, and/or alloys thereof. The glass included in the base electrode layers 131a and 132a may include, for example, one or more oxides of Ba, Ca, Zn, Al, B, and Si.

The base electrode layers 131a and 132a may be configured by only the sintered electrode layer, but the present disclosure may not be limited thereto, and the base electrode layers 131a and 132a may include, a sintered electrode layer including metal and glass, and a resin electrode layer disposed on the sintered electrode layer and including metal particles and resin.

The metal particles included in the resin electrode layer may include one or more of spherical particles and flake-shaped particles. The metal particles included in the resin electrode layer may include, for example, Cu, Ni, Pd, Pt, Au, Ag, Pb, Sn and/or alloys thereof. The resin included in the resin electrode layer may include, for example, one or more of epoxy resin, acrylic resin, and ethyl cellulose.

The plating layers 131b and 132b may include, for example, Ni, Sn, Pd and/or alloys thereof, and may be formed of a plurality of layers. The plating layers 131b and 132b may be, for example, Ni plating layer or Sn plating layer, and may also be in the form in which the Ni plating layer and the Sn plating layer are formed sequentially thereon. The plating layers 131b and 132b may include a plurality of Ni plating layers and/or a plurality of Sn plating layers.

Although the drawing describes a structure in which a multilayer electronic component 100 has two external electrodes 131 and 132, it may not be limited thereto, and the number or shape of the external electrodes 131 and 132 may be changed depending on shapes of the internal electrodes 121 and 122 or other purposes.

In an embodiment, the first and second external electrodes 131 and 132 may include a convex shape in the length direction on both end portions in the width direction. Referring to FIG. 7, it may be seen that, as the multilayer electronic component 100 includes the glass layers GL1 and GL2, the thickness of both end portions in the width direction may increase, thereby causing the first and second external electrodes 131 and 132 to have convex shapes at both end portions in the width direction.

In addition, the first and second external electrodes 131 and 132 may include a convex shape in the length direction at the center portion in the width direction. This may be formed by dipping the first and second external electrodes 131 and 132 into a paste for the external electrode.

In an embodiment, the glass layers GL1 and GL2 may include a first glass. The first glass may include one or more of Ba, Si, Zn, Ca, Al, and Mg. The external electrodes 131 and 132 may include base electrode layers 131a and 132a including a metal and a second glass. The second glass may include one or more of Ba, Si, Zn, Ca, Al, and Mg, but may have a different composition from the first glass.

In an embodiment, when a sum of number of moles of Ba and Si compared to a total number of moles of the elements excluding oxygen among elements configuring the first glass is M1, and a sum of number of moles of Ba and Si compared to a total number of moles of the elements excluding oxygen among elements configuring the second glass is M2, M1>M2 may be satisfied. When M1>M2 is satisfied, a softening temperature of the first glass may be higher than that of the second glass. Therefore, when forming the glass layers GL1 and GL2 after forming the base electrode layers 131a and 132a, the first glass may be prevented from softening, thereby a shape of the glass layers GL1 and GL2 may be maintained.

The components of the first and second glasses may be calculated from images observed using SEM-EDS (Scanning Electron Microscope-Energy Dispersive X-ray Spectroscopy). Specifically, after exposing cross-section in the length and width directions (L-W cross-section) polished to a center portion of the multilayer electronic component 100 in the thickness direction, a center region of the glass layers GL1 and GL2 may be analyzed for its components using ESD, and the M1 and M2 may be calculated based on the mol % of remaining elements excluding oxygen atoms.

FIG. 9A is an image scanned by SEM of a region corresponding to a P1 region of an embodiment of the present disclosure and FIG. 9B is an image captured by an optical microscope of a region corresponding to a P1 region of an embodiment of the present disclosure. Referring to FIGS. 9A and 9B, it may be confirmed that the 1-1 glass layer GL1-1 may be substantially configured of glass and is clearly distinguished from the base electrode layer 131a including metal and glass. Additionally, it may be confirmed that a shape of the 1-1 glass layer GL1-1 is well maintained even after the sintering process.

In an embodiment, the first and second glass layers GL1 and GL2 may have an area ratio of glass of 95% or greater in one cross-section. Accordingly, it may be clearly distinguished from the base electrode layer 131a including metal and glass.

A size of the multilayer electronic component 100 is not particularly limited. According to the present disclosure, since it is advantageous in miniaturization and high capacitance, it may be applied to a size of small IT products, and since it may secure high reliability in various environments, it may be also applied to a size of automotive electrical products requiring high reliability.

As illustrated in FIGS. 1 and 7, the side band portions Sb1 and Sb2 do not necessarily need to be disposed to cover all of the side-surface extension portions GL1-1b, GL1-2b, GL2-1b, and GL2-2b. In the case of a multilayer electronic component 100′ according to another embodiment of the present disclosure, the side-surface band portions Sb1′ and Sb2′ may be disposed to cover a portion of the side-surface extension portions GL1-1b′, GL1-2b′, GL2-1b′, and GL2-2b′.

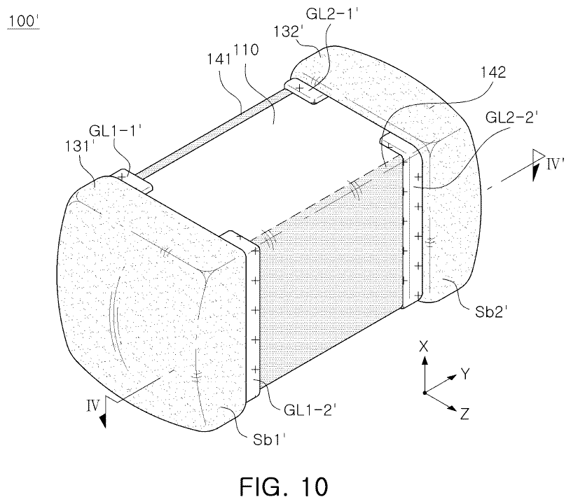

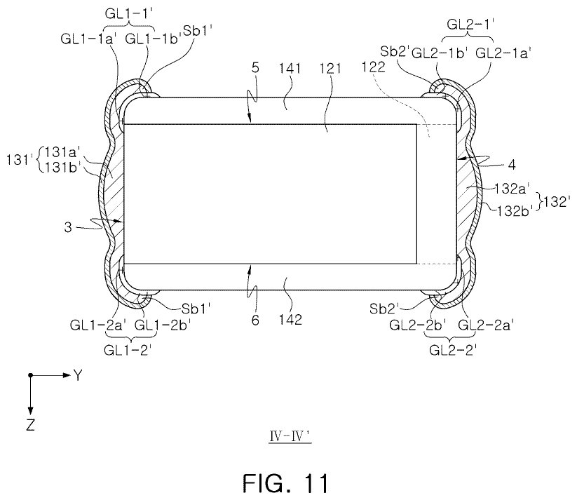

FIG. 10 schematically illustrates a perspective view of the multilayer electronic component 100′ according to another embodiment of the present disclosure, and FIG. 11 schematically illustrates a cross-sectional view taken along line IV-IV′ of FIG. 10. Referring to FIGS. 10 and 11, the first side-surface band portion Sb1′ of the first external electrode 131′ may be disposed to cover a portion of the first side-surface extension portions GL1-1b′ and GL1-2b′ of the first glass layers GL1-1′ and GL1-2′, and the second side-surface band portion Sb2′ of the second external electrode 132′ may be disposed to cover a portion of the second side-surface extension portions GL2-1b′ and GL2-2b′ of the second glass layers GL2-1′ and GL2-2′.

The 1-1 glass layer (GL1-1′) may include a region GL1-1a′ disposed on one surface of the first side margin portion 141 in the length direction and the 1-1 side-surface extension portion GL1-1b′ disposed extending to the external surface of the first side margin portion 141 in the width direction. The 2-1 glass layer GL2-1′ may include a region GL2-1a′ disposed on the other surface of the first side margin portion 141 in the length direction and the 2-1 side-surface extension portion GL2-1b′ disposed extending to the external surface of the first side margin portion 141 in the width direction. A 1-2 glass layer GL1-2′ may include a region GL1-2a′ disposed on one surface of the second side margin portion 142 in the length direction and a 1-2 side-surface extension portion GL1-2b′ disposed extending to the external surface of the second side margin portion 142 in the width direction. The 2-2 glass layer GL2-2′ may include a region GL2-2a′ disposed on the other side surface of the second side margin portion 142 in the length direction and the 2-2 side-surface extension portion GL2-2b′ disposed extending to the external surface of the second side margin portion 142 in the width direction.

In addition, the first and second glass layers GL1′ and GL2′ may include the upper and lower surface extension portions extending to both surfaces of the first side margin portion 141 in the thickness direction and both surfaces of the second side margin portion 142 in the thickness direction, respectively. In this case, the first and second external electrodes 131′ and 132′ each include upper and lower surface band portion extending to both surfaces of the first side margin portion in the thickness direction and to both surfaces of the second side margin portion in the thickness direction, and the upper and lower surface band portion may be disposed to cover all of the upper and lower extension portions.

### a Method for Manufacturing Multilayer Electronic Components

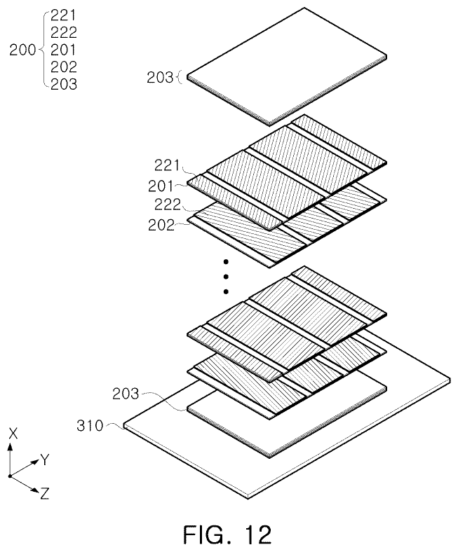

Hereinafter, a method for manufacturing a multilayer electronic component will be described in detail with reference to FIGS. 12 to 17. The method for manufacturing the multilayer electronic component described below is an example of manufacturing the multilayer electronic component 100 described above, and the multilayer electronic component 100 does not have to be manufactured only by the manufacturing method to be described later

### An Operation for Forming a Stacking Bar

Referring to FIG. 12, a stacking bar 200 may be obtained by stacking ceramic green sheets 201 and 202 having internal electrode patterns 221 and 222 printed thereon in the first direction. At least a portion of the stacking bar 200 may become a part forming the body 110 of the present disclosure after sintering.

In the manufacturing operation of the stacking bar 200, first, a plurality of ceramic green sheets 201 and 202 having the internal electrode patterns 221 and 222 disposed on a support film 310 are stacked.

The support film 310 may contribute to support the stacking bar 200 in which the internal electrode patterns 221 and 222 and a plurality of ceramic green sheets 201 and 202 are stacked. In this case, the support film 310 may include an adhesive material such as latex, starch, cellulose, protein, Isoprene Rubber (IR), Nitrile Butadiene Rubber (NBR), Styrene Butadiene Rubber (SBR), Chloroprene Rubber (CR), Silicon Rubber, Silicon-based, Urethane-based, Acryl-based, and mixtures thereof to effectively support and attach the stacking bar 200.

A plurality of ceramic green sheets 201 and 202 may be formed from a ceramic paste containing ceramic powder, an organic solvent, a dispersant, and a binder. The ceramic powder is a raw material for forming the dielectric layer 111 of the multilayer electronic component 100, and a barium titanate-based material, a lead composite perovskite-based material, or a strontium titanate-based material may be used. The barium titanate-based material may include BaTiO3-based ceramic powder, and the ceramic powder may be, for example, BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1) or Ba(Ti_{1-y}Zr_{y})O₃ (0<y<1) in which calcium (Ca), zirconium (Zr), or the like, are partially dissolved in BaTiO₃, and the like. When a plurality of ceramic green sheets 201 and 202 are sintered, they may become the dielectric layer 111 configuring the body 110.

In an embodiment, the stacking bar 200 may further include a ceramic green sheet 203 for the cover portion forming the cover portions 112 and 113. The ceramic green sheet 203 for the cover portion may be configured of the same materials and components as the ceramic green sheets 201 and 202, but is not limited thereto, and may form the first and second cover portions 112 and 113 through a sintering process. In this case, the ceramic green sheet 203 for the cover portion may be formed on one surface and the other surface of the stacking bar in the first direction, and may be formed as a single layer or a plurality of layers.

The internal electrode patterns 221 and 222 may be formed on the ceramic green sheets 201 and 202 by a paste for the internal electrode containing a conductive metal. The conductive metal included in the internal electrode patterns 221 and 222 is not particularly limited, and a material with excellent electrical conductivity may be used. For example, the conductive metal may include one or more of nickel (Ni), copper (Cu), palladium (Pd), silver (Ag), gold (Au), platinum (Pt), tin (Sn), tungsten (W), titanium (Ti), and alloys thereof. A method for forming the internal electrode patterns 221 and 222 on the ceramic green sheets 201 and 202 is not particularly limited. For example, the conductive paste for the internal electrode including the conductive metal may be formed by screen printing or gravure printing on the ceramic green sheets 201 and 202.

The internal electrode patterns 221 and 222 may be in striped shape. Specifically, the internal electrode pattern may be formed to contact both ends of the ceramic green sheets 201 and 202 in the third direction at a constant interval in the second direction.

The internal electrode patterns 221 and 222 may include a first internal electrode pattern 221 formed on a ceramic green sheet 201 and a second internal electrode pattern 222 formed on another ceramic green sheet 202.

### Operations for Obtaining a Unit Laminate

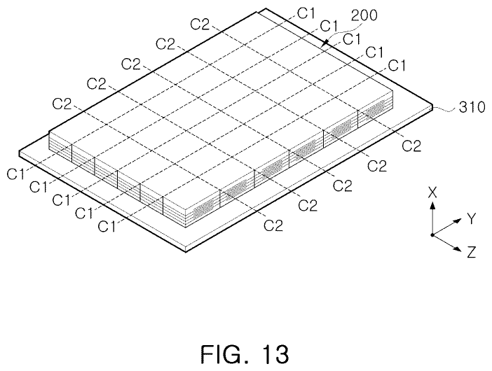

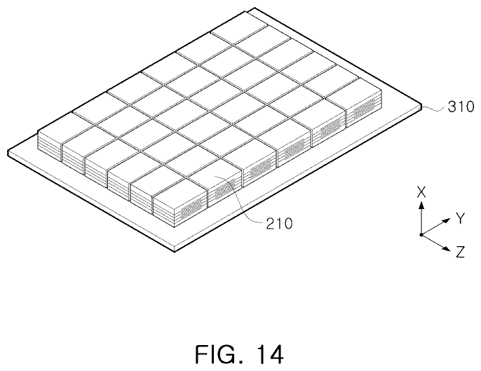

Referring to FIG. 13, the stacking bar 200 may be cut along cutting lines C1-C1 and C2-C2, which are orthogonal to each other. The C1-C1 cutting line is cutting line parallel to the second direction and are substantially equally spaced apart from each other in the third direction, and the C2-C2 cutting line is cutting line parallel to the third direction and may be substantially equally spaced apart from each other in the second direction. Accordingly, a plurality of unit laminates 210 may be obtained as illustrated in FIG. 14.

### Operations for Forming Side Margin Portions

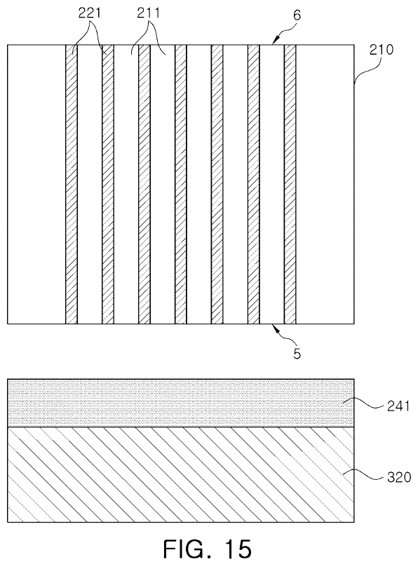

Next, as illustrated in FIG. 15, a ceramic green sheet 241 for the side margin portion may be attached to the side surface of the unit laminate 210 on which the ends of the first internal electrode pattern and the second internal electrode pattern are exposed.

A first side margin portion may be formed by attaching a ceramic green sheet 214 for the side margin portion to the fifth surface 5 of the unit laminate 210, and thereafter, a second side margin portion may be formed by attaching a ceramic green sheet for the side margin portion to the sixth surface 6 of the unit laminate 210.

Specifically, the method of forming the first side margin portion includes disposing the ceramic green sheet 241 for the side margin portion on an upper portion of an elastic punching member 320 formed of rubber.

Next, the unit laminate 210 is positioned so that a fifth surface 5 thereof faces the ceramic green sheet 241 for the side margin portion, and the unit laminate 210 is then pressed against the ceramic green sheet 241 for the side margin portion.

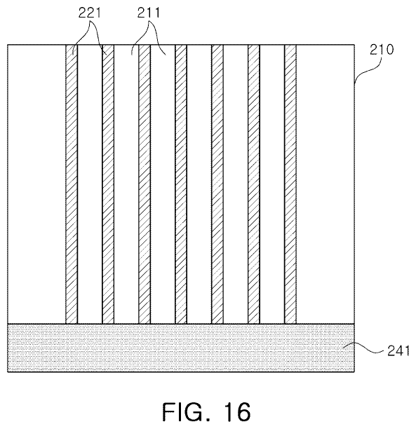

When the unit laminate 210 is pressed against the ceramic green sheet 241 for the side margin portion to transfer the ceramic green sheet 241 for the side margin portion onto the unit laminate 210, the ceramic green sheet 241 for the side margin is attached so as to cover the fifth surface 5 of the unit laminate 210, as shown in FIG. 16, and the remaining portion may be cut off due to the elastic punching member 320 formed of rubber.

Thereafter, the unit laminate 210 is rotated by 180 degrees, and the above-described process is repeated to form the second side margin portion on the sixth surface 6 of the unit laminate 210.

### An Operation for Forming a Glass Layer

Next, glass layers GL1 and GL2 may be formed.

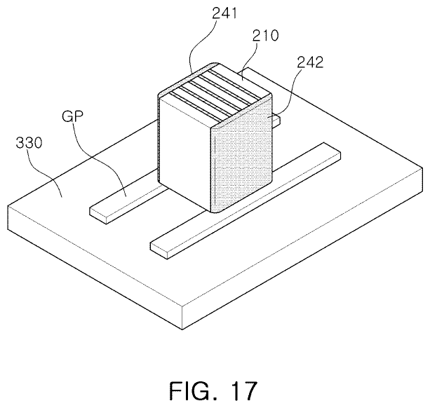

Referring to FIG. 17, after applying a paste GP for forming a glass layer in two lines on a platen 330, the unit laminate 210 having side margin portions 241 and 242 attached thereto may be transferred or dipped into the paste GP for forming a glass layer and then dried. Thereafter, the unit laminate 210 with the side margin portions 241 and 242 attached thereto may be rotated 180 degrees, and the above-described process may be repeated.

Thereafter, the glass layers GL1 and GL2 may be formed by sintering at a first temperature of 500° C. to 900° C.

Thereafter, the external electrodes 131 and 132 may be formed. For example, when the base electrode layers 131a and 132a include a sintered electrode layer, a conductive paste for external electrode including metal powder, second glass powder, binder, an organic solvent, or the like may be sintered at a second temperature of 500° C. to 900° C. to form the base electrode layers 131a and 132a. The base electrode layers 131a and 132a may be formed by applying the conductive paste for the external electrode on the glass layers GL1 and GL2 and then sintering them, but the present disclosure is not limited thereto.

In order to prevent the first glass from softening during a process for forming the base electrode layers 131a and 132a, the first temperature may be preferably higher than the second temperature. For example, the first temperature may be higher than the softening temperature of the first glass, and the second temperature may be lower than the softening temperature of the first glass and higher than the softening temperature of the second glass.

In addition, when the base electrode layers 131a and 132a include a resin electrode layer, a conductive resin composition including metal powder, resin, binder, and organic solvent may be applied onto the sintered electrode layer, followed by curing heat treatment at a temperature of 250° C. to 550° C. to form the resin electrode layer.

In addition, an electrolytic plating method and/or an electroless plating method may be further performed to form the plating layers 131b and 132b on the base electrode layers 131a and 132a.

Hereinafter, the present disclosure will be described in more detail through examples, but this is intended to help in a specific understanding of the present disclosure, and a scope of the present disclosure is not limited by the following examples.

### Example

Sample chips of test numbers 1 to 7 were prepared using the above-described method for manufacturing the multilayer electronic components.

However, in the case of test number 1, the external electrode was formed without forming a glass layer.

In the case of test number 2, the glass layer was formed so that the first glass layer was disposed on the first and second side margin portions but was spaced apart from the third surface of the body, and the second glass layer was disposed on the first and second side margin portions but was spaced apart from the fourth surface of the body.

In the case of test number 3, the glass layer was formed so that it was disposed only up to a boundary surface with the body, and the glass layer was formed so that it may not extend to the third and fourth surfaces.

In the case of test numbers 1 to 3, since the width Wb of the first internal electrode in the third direction and the width Wa of the first internal electrode in the third direction not covered by the first glass layer may be the same, Wa/Wb was defined as 1.0.

In the case of test numbers 4 to 7, the glass layer was formed so that Wa and Wb satisfied Table 1 below.

### The Moisture Resistance Reliability Evaluation

In the case of test numbers 1 to 7, 400 sample chips were mounted on a printed circuit board (PCB), and a voltage of 6.0 V was applied for 15 hours under conditions of temperature 85° C. and humidity 85%. When Insulation Resistance (IR) value decreased below 1/10 of the initial IR value, the sample was evaluated as defective, and then the number of defective samples was measured and illustrated in Table 1 below.

### ESR Evaluation

ESR was measured by using an LCR meter (frequency: 500 kHz, SMD Fixture type probe). For test numbers 1 to 7, ESR was measured on 400 sample chips respectively, and then average values are illustrated in Table 1 below.

The final evaluation was determined by considering both moisture resistance reliability and ESR, and was evaluated as excellent (⊚), good (◯), average (Δ), and poor (X).

TABLE 1

| Test | | Moisture resistance | ESR | |
|---|---|---|---|---|
| No. | Wa/Wb | reliability | (mΩ) | Evaluation |
| 1 | 0 | 60/400 | 1.94 | X |
| 2 | 1.07 | 30/400 | 1.95 | X |
| 3 | 1.00 | 10/400 | 1.95 | X |
| 4 | 0.98 | 1/400 | 2.01 | ◯ |
| 5 | 0.94 | 0/400 | 2.05 | ⊚ |
| 6 | 0.90 | 0/400 | 2.31 | Δ |
| 7 | 0.80 | 0/400 | 2.83 | X |

Referring to Table 1, it may be confirmed that the moisture resistance reliability of the sample chips is significantly low in the Test No. 1 because it does not include the glass layer, and it may be confirmed that the moisture resistance reliability of the sample chips is insufficient in Test No. 2 because the glass layer is spaced apart from the third and fourth surfaces of the body. In the case of test number 3, it may be confirmed that the moisture resistance reliability of the sample chips is not sufficient because the glass layer is disposed only up to the boundary surface with the body.

On the other hand, for test numbers 4 to 7, it may be confirmed that the moisture resistance reliability is significantly improved as the glass layer covers both end portions of the internal electrode with less than Wa/Wb. However, in the case of test number 7 where Wa/Wb is 0.80, ESR was rapidly increased to 2.83 mΩ, and thus the electrical characteristics of the sample chips were determined to be significantly deteriorated.

Although the embodiments of the present disclosure have been described in detail above, the present disclosure is not limited by the above-described embodiments and the accompanying drawings but is defined by the appended claims. Therefore, those skilled in the art may make various replacements, modifications, or changes without departing from the scope of the present disclosure defined by the appended claims, and these replacements, modifications, or changes should be construed as being included in the scope of the present disclosure.

In addition, the expression ‘one embodiment’ used in the present disclosure does not mean the same embodiment, and is provided to emphasize and explain different unique characteristics. However, the embodiments presented above do not preclude being implemented in combination with features of another embodiment. For example, although items described in a specific embodiment are not described in another embodiment, the items may be understood as a description related to another embodiment unless a description opposite or contradictory to the items is in another embodiment.

Terms used in this disclosure are only used to describe one embodiment, and are not intended to limit the disclosure. In this case, singular expressions include plural expressions unless the context clearly indicates otherwise.

While the embodiments have been illustrated and described above, it will be configured as apparent to those skilled in the art that modifications and variations could be made without departing from the scope of the present disclosure as defined by the appended claims.

1. A multilayer electronic component comprising:
a body including a dielectric layer and internal electrodes alternately disposed with the dielectric layer in a thickness direction, and including first and second surfaces opposing each other in the thickness direction, third and fourth surfaces opposing each other in a length direction, and fifth and sixth surfaces opposing each other in a width direction;
a first and second side margin portions respectively disposed on the fifth and sixth surfaces;
a first glass layer disposed on the first and second side margin portions and extending onto a portion of the third surface;
a second glass layer disposed on the first and second side margin portions and extending onto a portion of the fourth surface; and
a first and second external electrodes respectively disposed on the third and fourth surfaces,
wherein the internal electrode includes a first internal electrode having both ends in the width direction covered by the first glass layer on the third surface, and a second internal electrode having both ends in the width direction covered by the second glass layer on the fourth surface.

2. The multilayer electronic component of claim 1, wherein the first external electrode is disposed to cover at least a portion of the first glass layer,
wherein the second external electrode is disposed to cover at least a portion of the second glass layer.

3. The multilayer electronic component of claim 1, wherein the first internal electrode is exposed to the third, fifth and sixth surfaces of the body,
wherein the second internal electrode is exposed to the fourth, fifth and sixth surfaces of the body.

4. The multilayer electronic component of claim 1, wherein a width of the first internal electrode in a third direction is Wb, and a width of the first internal electrode in the third direction, that is not covered by the first glass layer is Wa,
an average value of Wa/Wb is 0.90 or more and 0.98 or less.

5. The multilayer electronic component of claim 1, wherein an average thickness of the first glass layer and the second glass layer is 5 μm or more and 15 μm or less, respectively.

6. The multilayer electronic component of claim 1, wherein the first glass layer includes a 1-1 glass layer disposed on one surface of the first side margin portion in the length direction and a 1-2 glass layer disposed on one surface of the second side margin portion in the length direction,
wherein the second glass layer includes a 2-1 glass layer disposed on the other surface of the first side margin portion in the length direction and a 2-2 glass layer disposed on the other surface of the second side margin portion in the length direction.

7. The multilayer electronic component of claim 6, wherein the 1-1 and 2-1 glass layers each include a side surface extension portion extend to outer surface of the first side margin portion in the width direction,
wherein the 1-2 and 2-2 glass layers each include a side surface extension portion extend to the outer surface of the second side margin portion in the width direction.

8. The multilayer electronic component of claim 7, wherein a length from an extension line of the outer surface of the first side margin portion in the width direction to an end of the 1-1 glass layer disposed on the third surface in the width direction is Le, and a length from an extension line of the third surface to an end of the side surface extension portion of the 1-1 glass layer in the length direction is Lf, Le/Lf is 0.8 or more and 1.2 or less

9. The multilayer electronic component of claim 1, wherein the first and second glass layers each include a side surface extension portion extend to an outer surface of the first side margin portion in the width direction and an outer surface of the second side margin portion in the width direction,
wherein the first and second external electrodes each include a side surface band portion extending to the outer surface of the first side margin portion in the width direction and the outer surface of the second side margin portion in the width direction.

10. The multilayer electronic component of claim 9, wherein the side surface band portion is disposed to cover entirety of side surface extension portion.

11. The multilayer electronic component of claim 9, wherein the side surface band portion is disposed to cover a portion of the side surface extension portion.

12. The multilayer electronic component of claim 1, wherein the first and second glass layers each include upper and lower surface extension portions extend to both surfaces of the first side margin portion in the thickness direction and both surfaces of the second side margin portion in the thickness direction.

13. The multilayer electronic component of claim 12, wherein the first and second external electrodes each include upper and lower surface band portions extend to both surfaces of the first side margin portion in the thickness direction and both surfaces of the second side margin portion in the thickness direction,
wherein the upper and lower surface band portions are disposed to cover entirety of upper and lower surface extension portions.

14. The multilayer electronic component of claim 12, wherein the first and second external electrodes each include upper and lower surface band portions extend to both surfaces of the first side margin portion in the thickness direction and both surfaces of the second side margin portion in the thickness direction,
wherein the upper and lower surface band portions are disposed to cover a portion of the upper and lower surface extension portions.

15. The multilayer electronic component of claim 1, wherein 4 vertices disposed at an edge of external surface of the first side margin portion in the width direction and 4 vertices disposed at the edge of external surface of the second side margin portion in the width direction are covered by the first glass layer or the second glass layer.

16. The multilayer electronic component of claim 1, wherein the first and second external electrodes include a convex shape in the length direction at both ends in the width direction.

17. The multilayer electronic component of claim 16, wherein the first and second external electrodes include a convex shape in the length direction at a central portion in the width direction.

18. The multilayer electronic component of claim 1, wherein the first and second glass layers have an area ratio of glass of 95% or more in one cross-section.

19. The multilayer electronic component of claim 1, wherein the first and second glass layers include a first glass including one or more of Ba, Si, Zn, Ca, Al, and Mg.

20. The multilayer electronic component of claim 19, wherein the first and second external electrodes include a base electrode layer including a metal and a second glass,
wherein a sum of number of moles of Ba and Si compared to a total number of moles of elements excluding oxygen among elements constituting the first glass is M1, and a sum of number of moles of Ba and Si compared to a total number of moles of elements excluding oxygen among elements constituting a second glass is M2, M1>M2 is satisfied.

21. A multilayer electronic component comprising:
a body including:
first internal electrodes exposed through a first surface of the body and spaced apart from a second surface opposing the first surface of the body in a length direction, and
second internal electrodes having exposed through the second surface of the body and spaced apart from the first surface, stacked alternately with the first internal electrodes in a thickness direction, with dielectric layers disposed therebetween;
first and second side margin portions disposed respectively on third and fourth surfaces of the body opposing each other in a width direction and contacting the first and second internal electrodes at corresponding edges thereof in the width direction;
a first glass layer disposed on edges of the body formed by the first surface with the third and fourth surfaces, and extending to a portion of the first surface;
a second glass layer disposed on edges of the body formed by the second surface with the third and fourth surfaces, and extending to portion the second surface; and
first and second external electrodes respectively disposed on the first and second surfaces of the body including portions of the first and second glass layers respectively extending on to the first and second surfaces of the body.

22. The multilayer electronic component of claim 21, wherein both the first and second glass layers extend to a portion of both the third and fourth surfaces.

23. The multilayer electronic component of claim 21, wherein both the first and second glass layers extend on to a portion of both fifth and sixth surfaces of the body opposing each other in the thickness direction.

24. A multilayer electronic component, comprising:
a body;
first internal electrodes extending to a first surface of the body and spaced apart from a second surface opposing the first surface of the body in a length direction;
second internal electrodes extending to the second surface of the body and spaced apart from the first surface;
dielectric layers disposed between adjacent first and second internal electrodes in a thickness direction;
first external electrode disposed on the first surface and directly contacting at least a portion the first internal electrodes extending to the first surface;
a first glass layer disposed on width-wise opposing edges of the first surface and having first portions extending on to a portion of the first surface, the first portions being disposed between the body and the first external electrode;
second external electrode disposed on the second surface and directly contacting at least a portion the second internal electrodes extending to the second surface;
a second glass layer disposed on width-wise opposing edges of the second surface and having second portions extending on to a portion of the second surface, the second portions being disposed between the body and the first external electrode.

25. The multilayer electronic component of claim 24, further comprising:
first and second margin portions disposed on width-wise opposing surfaces of the body such that width-wise opposing edges of the first and second internal electrodes respectively directly contact the first and second side margin portions.

26. The multilayer electronic component of claim 25, wherein the first glass layer extends on to portions of the first and second margin portions contacting width-wise opposing edges of the first surface of the body, and the second glass layer extends on to portions of the first and second margin portions contacting width-wise opposing edges of the second surface of the body.

27. The multilayer electronic component of claim 24, wherein an average value of a ratio Wa/Wb of a distance Wa between the first portions of the first glass layer along the width of the first surface to width Wb of the first and second internal electrodes is in a range from 0.90 to 0.98.
